(19) United States
(12) Patent Application Publication
(10) Pub. No.: US 2003/0036604 A1
(43) Pub. Date: Feb. 20, 2003

(54) Method for producing coatings from coating materials, which can be cured thermally and by using actinic radiation

(76) Inventors: Uwe Meisenburg, Duisburg (DE); Hubert Baumgart, Munster (DE); Jorge Prieto, Senden (DE); Roland Steinrucken, Bruchhausen (DE); Ludger Dornieden, Gronau (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/130,933

(22) PCT Filed: Dec. 5, 2000
(86) PCT No.: PCT/EP00/12188

(30) Foreign Application Priority Data
Dec. 20, 1999 (DE) 199 61 402.4

(51) Int. Cl. C08F 8/30

(52) U.S. Cl. 525/123

(57) ABSTRACT

The invention relates to a method for producing coatings from coating materials, which can be cured thermally and by using actinic radiation, on primed or non-primed substrates by: (1) applying at least one coating material, which can be cured thermally and by using actinic radiation, to a primed or non-primed substrate, whereby producing a layer that is comprised of the coating material, and; (2) curing the layer by using heat and actinic radiation. The inventive method is characterized in that a coating material is used that consists of:(A) compounds, which, with a statistical mean, contain at least one free isocyanate group and at least one bond per molecule that can be activated by means of actinic radiation; (B) (meth)acrylate copolymerizates that contain hydroxyl groups, and optionally of; C) additives selected from the group comprised of pigments, fillers, nanoparticles, bonding agents, reactive diluents, cross-linking agents for thermal curing, solvents, water, UV absorbers, light stabilizers, radical scavengers, initiators, catalysts for thermal cross-linking, degassing agents, slip additives, polymerization inhibitors, defoaming agents, emulsifiers, wetting and dispersing agents, adhesion promoters, flow-controlling agents, film-forming auxiliary agents, sag control agents (SCA), rheology controlling additives (thickeners), flame proofing agents, siccatives, drying agents, skinning inhibitors, corrosion inhibitors, waxes and delustering agents.

The present invention relates to a novel process for producing coatings from coating materials curable thermally and with actinic radiation.

Coating materials curable thermally and with actinic radiation, which are also referred to as dual-cure coating materials, and processes for producing coatings from them are known from European patent EP-A-0 928 800. The known coating material mandatorily comprises a urethane (meth)acrylate, containing (meth)acrylate groups and free isocyanate groups, a UV initiator (photoinitiator) which initiates free-radical polymerization, and an isocyanate-reactive compound. Suitable isocyanate-reactive compounds include polyols such as polyesters formed from diols and triols and also diacarbotylic acids, hindered amines formed from maleic esters and cycloaliphatic primary diamines, polyether polyols or hydroxyl-containing (meth)acrylate copolymers.

The known dual-cure coating material has the advantage that, on the one hand, incomplete thermal curing, carried out deliberately in order to protect thermally sensible substrates, for example, may be compensated by the UV cure or an incomplete cure with UV light, occurring for example in shadow regions of substrates of complex shape, may be compensated by the thermal cure, so that in both cases the overall result is very good.

A disadvantage, on the other hand, is that the use of photoinitiators leads to emissions of decomposition products, some of them entailing an intense odor and/or leading to yellowing of the coatings.

It is an object of the present invention to find a novel process for producing coatings from dual-cure coating materials which provides yellowing-free and emission-free coatings while maintaining the depicted advantages of the dual-cure systems.

Found accordingly has been the novel process for producing coatings from coating materials curable thermally and with actinic radiation on primed and unprimed substrates by

(1) applying at least one coating material curable thermally and with actinic radiation to the primed or unprimed substrate or to a basecoat film present thereon, to give a film of the coating material, and

(2) curing the film with heat and actinic radiation,

using a coating material which is composed of

A) at least one compound containing on average per molecule at least one free isocyanate group and at least one bond which can be activated with actinic radiation, and also

B) at least one hydroxyl-containing (meth)acrylate copolymer

or at least one constituent (A), at least one constituent (B), and

C) at least one additive selected from the group consisting of color and/or effect pigments, organic and inorganic, transparent or opaque fillers, nanoparticles, oligomeric and polymeric binders, reactive diluents curable thermally and/or with actinic radiation, crosslinking agents for the thermal cure, low and high-boiling organic solvents (long solvents), water, UV absorbers, light stabilizers, free-radical scavengers, thermolabile free-radical initiators, thermal crosslinking catalysts, devolatilizers, slip additives, polymerization inhibitors, defoamers, emulsifiers, wetting agents, dispersants, adhesion promoters, leveling agents, film-forming auxiliaries, sag control agents (SCA), rheology control additives (thickeners), flame retardants, siccatives, dryers, antiskinning agents, corrosion inhibitors, waxes, and flatting agents.

The novel process for producing coatings from coating materials curable thermally and with actinic radiation is referred to below as “process of the invention”.

In the light of the prior art it was surprising and unforeseeable for the skilled worker that the specific combination of the constituents (A) and (B) or (A), (B) and (C) can be cured thermally and with actinic radiation, without the use of photoinitiators, the curing with actinic radiation taking place at comparatively low temperatures of less than 50° C.

The process of the invention is used to produce coatings, especially single-coat and multicoat clearcoat systems and color and/or effect paint systems, on primed or umprimed substrates.

Suitable coating substrates are all surfaces which are undamaged by curing of the coatings present thereon using heat and actinic radiation combined; examples include metals, plastics, wood, ceramic, stone, textile, fiber composites, leather, glass, glass fibers, glass wool, rock wool, mineral- and resin-bound building materials, such as plasterboard panels and cement slabs or roof shingles, and also composites of these materials. Accordingly, the process of the invention is also suitable for applications outside of automotive finishing. In that context it is especially suitable for coating furniture and for industrial coating, including coil coating, container coating, and the impregnation or coating of electrical components. In the context of industrial coatings it is suitable for coating virtually all parts for private or industrial use, such as radiators, domestic appliances, small metal parts such as nuts and bolts, hub caps, wheel rims, packaging, or electrical components such as motor windings or transformer windings.

In the case of electrically conductive substrates it is possible to use primers, which are produced conventionally from electrocoat materials. Both anodic and cathodic electrocoats are suitable for this purpose, but especially cathodics. In the case of metal, the substrate may also have been subjected to a surface treatment, such as a galvanizing or phosphating or Eloxing treatment, for example.

Especially in automotive OEM finishing, a surfacer or an antistonechip primer is applied to the fully cured or merely dried electrocoat. The resulting film is fully cured either on its own or together with the underlying electrocoat film. The applied surfacer film may also be merely dried or partly cured, after which it is fully cured together with the overlying films and also, where appropriate, with the underlying electrocoat film (extended wet-on-wet techniques). In the context of the present invention, the term “primer” also embraces the combination of electrocoat and surfacer or antistonechip primer.

Using the process of the invention it is also possible to coat primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM, and UP (abbreviations as per DIN 7728T1). The plastics to be coated may of course also be polymer blends, modified plastics or fiber-reinforced plastics. It is also possible to employ the plastics that are commonly used in vehicle construction, especially motor vehicle construction.

Unfunctionalized and/or polar substrate surfaces may be subjected prior to coating in a known manner to a pretreatment, such as with a plasma or by flaming, or may be provided with a water-based primer.

In a first advantageous variant of the process of the invention, in the first process step the coating material for use in accordance with the invention that is described below and is curable thermally and with actinic radiation is applied to the primed or umprimed substrate to give a film of the dual-cure coating material for inventive use. This process variant is employed in particular in the production of single-coat clearcoat systems or color and/or effect paint systems.

In a second advantageous variant of the process of the invention, in the first process step the dual-cure coating material for inventive use is applied to at least one basecoat film that is present on the substrate. The basecoat film may also be a film of a pigmented dual-cure coating material. Preferably, the basecoat film has been merely dried or partly cured, so that it can be cured together with the film of the dual-cure coating material (wet-on-wet technique).

In a third variant of the process of the invention, in the first process step the pigmented dual-cure coating material for inventive use is applied and is overcoated with a customary and known clearcoat material, after which the two films are cured together (wet-on-wet technique).

The second and the third variants, but especially the second variant, of the process of the invention are employed in particular in producing multicoat color and/or effect paint systems.

The dual-cure coating material for inventive use may be applied by any customary application method, such as spraying, knifecoating, brushing, flowcoating, dipping, impregnating, trickling or rolling, for example. The substrate to be coated may itself be at rest, with the application equipment or unit being moved. Alternatively, the substrate to be coated, in particular a coil, may be moved, with the application unit being at rest relative to the substrate or being moved appropriately.

Preference is given to employing spray application methods, such as compressed air spraying, airless spraying, high-speed rotation, electrostatic spray application (ESTA), alone or in conjunction with hot spray application such as hot air spraying, for example. Application may be made at temperatures of max. 70 to 80° C., so that appropriate application viscosities are achieved without any change or damage to the dual-cure coating material for inventive use and its overspray (which may be intended for reprocessing) occurring during the short period of thermal stress. For instance, hot spraying may be configured in such a way that the dual-cure coating material for inventive use is heated only very briefly in the spray nozzle or shortly before the spray nozzle.

The spray booth used for the application may, for example, be operated with a circulation system which may be temperature-controllable, and which is operated with an appropriate absorption medium for the overspray, an example of such medium being the dual-cure coating material for inventive use.

Preferably, application is conducted under illumination with visible light with a wavelength of more than 550 μm or in the absence of light, if the aqueous basecoat material is curable thermally and with actinic radiation. This prevents material alteration or damage to the dual-cure coating material for inventive use and the overspray.

In general, the dual-cure coating materials for inventive use are applied in a wet film thickness such that curing thereof results in coats having the thicknesses which are advantageous and necessary for their functions. In the case of a basecoat this thickness is from 5 to 50 μm, preferably from 5 to 40 μm, with particular preference from 5 to 30 μm, and in particular from 10 to 25 μm, and in the case of a clearcoat it is from 10 to 100 μm, preferably from 15 to 80 μm, with particular preference from 20 to 75 μm, and in particular from 25 to 70 μm.

Of course, the application methods described above may also be employed when producing the other coating films as part of the process of the invention.

In the context of the process of the invention, the film of the dual-cure coating material for inventive use, following its application, is cured thermally and with actinic radiation. It is preferred here to employ the methods described above of thermal curing and also the methods described below of curing with actinic radiation.

By actinic radiation is meant electromagnetic radiation such as visible light, UV radiation and X-rays, especially UV radiation, or copacular radiation such as electron beams. It is preferred to employ UV radiation and/or electron beams, particularly UV radiation.

In the context of the process of the invention, curing may be carried out immediately following the application of the film of the dual-cure coating material for inventive use. If desired, underlying coating films which have not yet been fully cured may be cured as well in this operation. It is of advantage in accordance with the invention if the primer has already been fully cured.

Curing may take place after a certain rest or flashoff time. This time may have a duration of from 30 s to 2 h, preferably from 1 min to 1 h, and in particular from 1 min to 45 min. The rest is used, for example, for leveling and devolatilization of the films and for the evaporation of volatile constituents such as any solvent still present.

Curing with actinic radiation is preferably carried out employing a dose of from 1000 to 2000, more preferably from 1100 to 1900, with particular preference from 1200 to 1800, with very particular preference from 1300 to 1700, and in particular from 1400 to 1600 mJ/cm². If desired, this curing may be supplemented with actinic radiation from other radiation sources. In the case of electron beams, it is preferred to operate under an inert gas atmosphere. This may be ensured, for example, by supplying carbon dioxide and/or nitrogen directly to the surface of the clearcoat film I. In the case of curing with UV radiation as well it is possible to operate under inert gas in order to prevent the formation of ozone.

Curing with actinic radiation is carried out using the customary and known radiation sources and optical auxiliary measures. Examples of suitable radiation sources are flashlamps from the company VISIT, high or low pressure mercury vapor lamps, with or without lead doping in order to open up a radiation window up to 405 nm, or electron beam sources. Their arrangement is known in principle and may be adapted to the circumstances of the workpiece and the process parameters. In the case of workpieces of complex shape, as are envisaged for automobile bodies, those regions not accessible to direct radiation (shadow regions) such as cavities, folds, and other structural undercuts may be (partly) cured using pointwise, small-area or all-round emitters in conjunction with an automatic movement device for the irradiation of cavities or edges.

The equipment and conditions for these curing methods are described, for example, in R. Holmes, U.V. and E.B. Curing Formulations for Printing Inks, Coatings and Paints, SITA Technology, Academic Press, London, United Kingdom 1984.

Curing in this case may take place in stages, i.e., by multiple exposure to light or actinic radiation. It may also take place alternately, i.e., by curing alternately with UV radiation and electron beams.

Thermal curing as well has no special features in terms of its method but instead takes place in accordance with the customary and known methods such as heating in a forced air oven or irradiation using IR lamps. As is the case with actinic radiation curing, thermal curing may also take place in stages. Thermal curing advantageously takes place at temperatures below 100° C. in particular 90° C.

Thermal curing and actinic radiation curing are employed simultaneously or successively. Where the two curing methods are used successively, it is possible, for example, to begin with thermal curing and end with actinic radiation curing. In other cases it may prove advantageous to begin and to end with actinic radiation curing. Particular advantages result if the film of the dual-cure coating material for inventive use is cured in two separate process steps, first thermally and then with actinic radiation.

In the context of the process of the invention, the above-described curing methods may of course also be used to cure the other coating films.

The single-coat or multicoat clearcoat system or color and/or effect paint system resulting from the process of the invention may further be coated with a layer of an organically modified ceramic material, as obtainable commercially, for example, under the brand name Ormocer®.

The dual-cure coating material to be used for the process of the invention is composed of the two constituents (A) and (B) or of the three constituents (A), (B) and (C).

The constituent (A) is at least one compound containing an average per molecule of at least one, in particular at least two, free isocyanate group(s) and at least, in particular at least two, bond(s) which can be activated with actinic radiation. The compound (A) is customarily free from aromatic structures.

For the purposes of the present invention, a bond which can be activated with actinic radiation is a bond which on exposure to actinic radiation becomes reactive and enters, with other activated bonds of its kind, into polymerization reactions and/or crosslinking reactions which proceed in accordance with free-radical and/or ionic mechanisms. Examples of suitable bonds are carbon-hydrogen single bonds or carbon-carbon, carbon-oxygen, carbon-nitrogen, carbon-phosphorus or carbon-silicon single or double bonds. Of these, the carbon-carbon double bonds are particularly advantageous and are therefore used with very particular preference in accordance with the invention. For the sake of brevity, they are referred to below as “double bonds”.

Particularly suitable double bonds are present, for example, in (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups. Of these, the acrylate groups afford very particular advantages and so are used with very particular preference in accordance with the invention.

Examples of suitable isocyanate-reactive functional groups are thio, hydroxyl, amino and/or imino groups, especially thio, hydroxyl and/or amino groups, particularly hydroxyl groups.

The compound (A) is obtainable by the reaction of polyisocyanates containing on average per molecule at least 2.0, preferably more than 2.0, and in particular more than 3.0 isocyanate groups per molecule with compounds which contain at least one, especially one, bond which can be activated with actinic radiation and at least one, especially one, isocyanate-reactive group.

There is basically no upper limit on the number of isocyanate groups in the polyisocyanates; in accordance with the invention, however, it is of advantage if the number does not exceed 15, preferably 12, with particular preference 10, with very particular preference 8.0 and in particular 6.0.

Examples of suitable polyisocyanate are polyurethane prepolymers which contain isocyanate groups, can be prepared by reacting polyols with an excess of aliphatic and cycloaliphatic diioscyanates, and are preferably of low viscosity. For the purposes of the present invention, the term “cycloaliphatic diisocyanate” designates a diisocyanate in which at least one isocyanate group is attached to a cycloaliphatic radical.

Examples of suitable cycloaliphatic diisocyanates are isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane dicyclohexylmethane 2,4′-diisocyanate or dicyclohexylmethane 4,4′-diisocyanate, especially isophorone diisocyanate.

Examples of suitable acyclic aliphatic diisocyanates for inventive use are trimethylene diisocyanate, tetramethylene diisocyanate, pentamethylene diisocyanate, hexamethylene diisocyanate, ethylethylene diisocyanate, trimethylhexane diisocyanate, heptamethylene diisocyanate, or diisocyanates derived from dimer fatty acids, as sold under the commercial designation DDI 1410 by Henkel and described in the patents DO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane or 1,2-, 1,4- or 1,3-bis(4-isocyanatobut-1-yl)cyclohexane.

Of these, hexamethylene diisocyanate is of particular advantage and is therefore used with very particular preference in accordance with the invention.

It is also possible to use polyisocyanates which contain isocyanurate, biuret, allophanate, iminooxadiazinedione, urethane, urea, carbodiimide and/or uretdione groups and which are prepared in a customary and known manner from the above-described diisocyanates. Examples of suitable preparation processes and polyisocyanates are known, for example, from patents CA-A-2 163 591, U.S. Pat. No. 4,419,513, U.S. Pat. No. 4,454,317, EP-A-0 646 608, U.S. Pat. No. 4,801,675, EP-A-0 183 976, DE-A-40 15 155, EP-A-0 303 150, EP-A-0 496 208, EP-A-0 524 500, EP-A-0 566 037, U.S. Pat. No. 5,258,482, U.S. Pat. No. 5,290,902, EP-A-0 649 806, DE-A-42 29 183 or EP-A-0 531 820.

Examples of suitable compounds containing at least one, isocyanate-reactive group and at least one bond which can be activated with actinic radiation are

allyl alcohol or 4-butyl vinyl ether;

hydroxyalkyl esters of acrylic acid or of methacrylic acid, especially of acrylic acid, which are obtainable by esterifying aliphatic diols, examples being the low molecular mass diols B) described above, with acrylic acid or methacrylic acid or by reacting acrylic acid or methacrylic acid with an alkylene oxide, especially hydroxyalkyl esters of acrylic acid or methacrylic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl, bis(hydroxymethyl)cyclohexane acrylate or methacrylate; of these, 2-hydroxyethyl acrylate and 4-hydroxybutyl acrylate are especially advantageous and are therefore used with particular preference in accordance with the invention; or

reaction products of cyclic esters, such as epsilon-caprolactone, for example, and these hydroxyalkyl or hydroxycycloalkyl esters.

The polyisocyanates are reacted with the compounds containing at least one bond which can be activated with actinic radiation and at least one isocyanate-reactive group, in a molar ratio such that on average there remains at least one free isocyanate group per molecule.

Viewed in terms of method this reaction has no special features but instead is carried out as described, for example, in European patent EP-A-0 928 800.

The amount of compounds (A) in the dual-cure coating materials for inventive use may vary very widely. It is guided in particular by the functionality and by the amount of constituent (B) and also, where appropriate, of reactive diluents (C) present.

The dual-cure coating material of the invention is further composed of at least one hydroxyl-containing (meth)acrylate copolymer (B).

The hydroxyl-containing (meth)acrylate copolymers (B) contain primary and/or secondary hydroxyl groups. It is a very substantial advantage of the process of the invention that both types of hydroxyl group may be used. This makes it possible to tailor the reactivity of the hydroxyl-containing (meth)acrylate copolymers (B) by way of steric effects.

Highly suitable hydroxyl-containing (meth)acrylate copolymers (B) are obtained by copolymerization of the olefinic saturated monomers (b), described below, of which at least one contains at least one hydroxyl group and is substantially free from acid groups.

Examples of suitable hydroxyl-containing monomers (b1) are hydroxyalkyl esters of acrylic acid, methacrylic acid or another alpha,beta-ethylenically unsaturated carboxylic acid, which derive from an alkylene glycol which is esterified with the acid, or are obtainable by reacting the acid with an alkylene oxide, especially hydroxyalkyl esters of acrylic acid, methacrylic acid or ethacrylic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate or crotonate; 1,4-bis(hydroxymethyl)cyclohexane, octahydro-4,7-methano-1H-indenedimethanol or methylpropanediol monoacrylate, monomethacrylate, monoethacrylate or monocrotonate; or reaction products of cyclic esters, such as ε-caprolactone, for example, and these hydroxyalkyl esters; or olefinically unsaturated alcohols such as allyl alcohol or ethers of polyols such as trimethylolpropane diallyl ether or pentaerythritol diallyl or triallyl ether. These monomers (b1) of higher functionality are generally used only in minor amounts. In the context of the present invention, minor amounts of higher-functional monomers here are those amounts which do not lead to crosslinking or gelling of the polyacrylate resins. For example, the fraction of trimethylolpropane diallyl ether may be from 2 to 10% by weight, based on the overall weight of the monomers (b1) to (b6) used to prepare the hydroxyl-containing (meth)acrylate copolymers (B). The monomers (b1) may be used as the monomers (b), in which case at least one (meth)acrylate (b1) is employed. In accordance with the invention, however, it is of advantage to use them in combination with further monomers (b).

Examples of suitable further monomers (b) are:

Monomers (b2):

(Meth)acrylic alkyl or cycloalkyl esters having up to 20 carbon atoms in the alkyl radical, especially methyl, ethyl, propyl, n-butyl, sec-butyl, tert-butyl, hexyl, ethylhexyl, stearyl and lauryl acrylate or methacrylate; cycloaliphatic(meth)acrylic esters, especially cyclohexyl, isobornyl, dicyclopentadienyl, octahydro-4,7-methano-1H-indenemethanol or tertbutylcyclohexyl (meth)acrylate; (meth)acrylic oxaalkyl esters or oxacycloalkyl esters such as ethyltriglycol (meth)acrylate and methoxyoligoglycol (meth)acrylate having a molecular weight Mn of preferably 550; or other ethoxylated and/or propoxylated, hydroxyl-free (meth)acrylic acid derivatives. These may include, in minor amounts, higher-functional (meth)acrylic alkyl or cycloalkyl esters such as ethylene glycol, propylene glycol, diethylene glycol, dipropylene glycol, butylene glycol, 1,5-pentanediol, 1,6-hexanediol, octahydro-4,7-methano-1H-indenedimethanol or cyclohexane-1,2-, -1,3- or -1,4-diol di(meth)acrylate; trimethylolpropane di- or tri(meth)acrylate; or pentaerythritol di-, tri- or tetra(meth)acrylate. In the context of the present invention, minor amounts of higher-functional monomers (b2) here are those which do not lead to crosslinking or gelling of the polyacrylate resins.

Monomers (b3):

Ethylenically unsaturated monomers which carry at least one acid group, preferably a carboxyl group, per molecule, or a mixture of such monomers. As component (b3) use is made with particular preference of acrylic acid and/or methacrylic acid. However, it is also possible to use other ethylenically unsaturated carboxylic acids having up to 6 carbon atoms in the molecule. Examples of such acids are ethacrylic acid, crotonic acid, maleic acid, fumaric acid, and itaconic acid. It is also possible to use ethylenically unsaturated sulfonic or phosphonic acids, and/or their partial esters, as component (b3). Further suitable monomers (b3) include mono(meth)acryloyloxyethyl maleate, succinate, and phthalate.

Monomers (b4):

Vinyl esters of alpha-branched monocarboxylic acids having 5 to 18 carbon atoms in the molecule. The branched monocarboxylic acids may be obtained by reacting formic acid or carbon monoxide and water with olefins in the presence of a liquid, strongly acidic catalyst; the olefins may be cracking products of paraffinic hydrocarbons, such as mineral oil fractions, and may comprise both branched and straight-chain acyclic and/or cycloaliphatic olefins. The reaction of such olefins with formic acid and/or with carbon monoxide and water produces a mixture of carboxylic acids in which the carboxyl groups are located predominantly on a quaternary carbon atom. Examples of other olefinic starting materials are propylene trimer, propylene tetramer, and diisobutylene. Alternatively, the vinyl esters may be prepared conventionally from the acids, for example, by reacting the acid with acetylene. Particular preference is given—owing to their ready availability—to vinyl esters of saturated aliphatic monocarboxylic acids having 9 to 11 carbon atoms that are branched on the alpha carbon atom.

Monomers (b5):

Reaction product of acrylic acid and/or methacrylic acid with the glycidyl ester of an alpha-branched monocarboxylic acid having 5 to 18 carbon atoms per molecule. The reaction of the acrylic or methacrylic acid with the glycidyl ester of a carboxylic acid having a tertiary alpha carbon atom may take place before, during or after the polymerization reaction. As component (b5) it is preferred to use the reaction product of acrylic and/or methacrylic acid with the glycidyl ester of Versatic® acid. This glycidyl ester is available commercially under the name Cardura® E10. For further details, refer to Römpp Lexikon Lacke und Druckfarben, Georg Thieme Verlag, Stuttgart, New York, 1998, pages 605 and 606.

Monomers (b6):

Ethylenically unsaturated monomers which are substantially free from acid groups, such as

olefins such as ethylene, propylene, 1-butene, 1-pentene, 1-hexene, cyclohexene, cyclopentene, norbornene, butadiene, isoprene, cyclopentadiene and/or dicyclopentadiene;

(meth)acrylamides such as (meth)acrylamide, N-methyl-, N,N-dimethyl-, N-ethyl, N,N-diethyl, N-propyl, N,N-dipropyl, N-butyl, N,N-dibutyl, N-cyclohexyl- and/or N,N-cyclohexyl methyl(meth)acrylamide;

monomers containing epoxide groups, such as the glycidyl ester of acrylic acid, methacrylic acid, ethacrylic acid, crotonic acid, maleic acid, fumaric acid and/or itaconic acid;

vinylaromatic hydrocarbons, such as styrene, alpha-alkylstyrenes, especially alpha-methylstyrene, arylstyrenes, especially diphenylethylene, and/or vinyltoluene;

nitriles such as acrylonitrile and/or methacrylonitrile;

vinyl compounds such as vinyl chloride, vinyl fluoride, vinylidene dichloride, vinylidene difluoride; N-vinylpyrrolidone; vinyl ethers such as ethylvinyl ether, n-propyl vinyl ether, isopropyl vinyl ether, n-butyl vinyl ether, isobutyl vinyl ether and/or vinyl cyclohexyl ether; vinyl esters such as vinyl acetate, vinyl propionate, vinyl butyrate, vinyl pivalate, vinyl esters of Versatic® acids, which are marketed under the brand name VeoVa® by the company Deutsche Shell Chemie (for further details, refer to Römpp Lexikon Lacke und Druckfarben, Georg Thieme Verlag, Stuttgart, New York, 1998, page 598 and also pages 605 and 606), and/or the vinyl ester of 2-methyl-2-ethylheptanoic acid; and/or

polysiloxane macromonomers having a number-average molecular weight Mn of from 1000 to 40,000, preferably from 2000 to 20,000, with particular preference from 2500 to 10,000, and in particular from 3000 to 7000 and having on average from 0.5 to 2.5, preferably from 0.5 to 1.5, ethylenically unsaturated double bonds per molecule, as described in DE-A-38 07 571 on pages 5 to 7, in DE-A-37 06 095 in columns 3 to 7, in EP-B-0 358 153 on pages 3 to 6, in U.S. Pat. No. 4,754,014 in columns 5 to 9, in DE-A-44 21 823 or in the international patent application WO 92/22615 on page 12 line 18 to page 18 line 10, or acryloxysilane-containing vinyl monomers, preparable by reacting hydroxy-functional silanes with epichlorohydrin and subsequently reacting that reaction product with (meth)acrylic acid and/or hydroxyalkyl esters of meth acrylic acid.

In accordance with the invention it is of particular advantage to select the monomers (b) so as to give hydroxyl-containing (meth)acrylate copolymers (B) which preferably have an OH number of from 100 to 250, more preferably from 130 to 210, acid numbers of from 0 to 80, more preferably from 0 to 50, with very particular preference from 0 to 15, glass transition temperatures, Tg, of from −25 to +80° C., more preferably from −20 to +40° C., and preferably molecular average/weights from 1500 to 30,000, preferably from 1500 to 15,000, with very particular preference from 1500 to 5000 (determined by gel permeation chromatography using polystyrene as internal standard).

The glass transition temperature Tg of the hydroxyl-containing (meth)acrylate copolymers (B) is determined by the nature and amount of the monomers (b1) and, where appropriate (b2), (b3), (b4), (b5) and/or (b6) that are used. The skilled worker is able to select the monomers (b) with assistance from the following formula of Fox, by means of which the glass transition temperatures Tg of (co)polymers, especially polyacrylate resins, may be calculated to an approximation:

$$1 / Tg = {\sum }_{n = 1}^{n = x} Wn / Tgn ; {\sum }_{n} {W}_{n} = 1$$

Tg=glass transition temperature of the hydroxyl-containing (meth)acrylate copolymer (B)

Wₙ=weight fraction of the nth monomer

Tgₙ=glass transition temperature of the homopolymer of the nth monomer

X=number of different monomers

Viewed in terms of its method, the preparation of the hydroxyl-containing (meth)acrylate copolymers (B) has no special features but instead takes place in accordance with the customary and known methods of free-radical polymerization in the presence of at least one polymerization initiator in bulk or in solution.

Examples of suitable polymerization initiators are initiators which form free radicals, such as dialkyl peroxides such as di-tert-butyl peroxide or dicumyl peroxide; hydroperoxides such as cumol hydroperoxide or tert-butyl hydroperoxide; peresters, such as tert-butyl perbenzoate, tert-butyl perpivalate, tert-butyl per-3,5,5-trimethylhexanoate or tert-butyl per-2-ethylhexanoate; azo dinitriles such as azobisisobutyronitrile; C-C-cleaving initiators such as benzpinacol silyl ethers. It is preferred to use oil-soluble initiators. The initiators are used preferably in an amount of from 0.1 to 25% by weight, with particular preference from 0.75 to 10% by weight, based on the overall weight of the monomers (b).

The polymerization is appropriately conducted at a temperature from 80 to 200° C., preferably 110 to 180° C.

As solvents it is preferred to use the below-described organic solvents (C) which are inert toward isocynate groups, especially mixtures of aromatic hydrocarbons or esters, ethers and/or ketones, or reactive diluents (C) for thermal crosslinking. The solvents may serve as additive (C) in the dual-cure coating material for inventive use.

The hydroxyl-containing (meth)acrylate co-polymers (B) can be prepared by a two-stage process or a one-stage process.

In the case of a two-stage process

1. a mixture of the monomers (b1) and also, where appropriate, (b2), (b4), (b5) and/or (b6) or a mixture of portions of the monomers (b1) and also, where appropriate, (b2), (b4), (b5) and/or (b6) is polymerized in an organic solvent, and

2. after at least 60% by weight of the mixture of (b1) and also, where appropriate, (b2), (b4), (b5) and/or (b6) has been added, the monomer (b3) and any remainder of the monomers (b1) and also, where appropriate, (b2), (b4), (b5) and/or (b6) is or are added and polymerization continued.

In addition, however, it is also possible to introduce the monomers (b4) and/or (b5) as an initial charge together with at least one portion of the solvent and to meter in the remaining monomers. Moreover, it is also possible for only some of the monomers (b4) and/or (b5) to be included in the initial charge together with at least one portion of the solvent and for the remainder of these monomers to be added as described above. Preference is given, for example, to including at least 20% by weight of the solvent and about 10% by weight of the monomers (b4) and (b5) and also, where appropriate, portions of the monomers (b1) and (b6) in the initial charge.

It is preferred to commence the addition of initiators some time, generally from about 1 to 15 minutes, before the addition of the monomers. Preference is further given to a process wherein the addition of initiator is commenced at the same point in time as the addition of the monomers and ended about half an hour after the addition of the monomers has been ended. The initiator is preferably added in a constant amount per unit time. After the end of the addition of initiator, the reaction mixture is held at polymerization temperature until (generally 1.5 hours) all of the monomers used have undergone substantially complete reaction. “Substantially complete reaction” is intended to denote that preferably 100% of the monomers used have been reacted but it is also possible for a small residual monomer content of not more than up to about 0.5% by weight, based on the weight of the reaction mixture, to remain unreacted.

The monomers (b) for preparing the hydroxyl-containing (meth)acrylate copolymers (B) are preferably copolymerized at not too high a polymerization solids, preferably at a polymerization solids of 80 to 50% by weight, based on the monomers (b).

In terms of apparatus as well the preparation of the hydroxyl-containing (meth)acrylate copolymers (B) has no special methodological features but instead takes place by means of the methods—customary and known in the plastics field—of continuous or batchwise copolymerization under atmospheric or super-atmospheric pressure in stirred tanks, autoclaves, tube reactors or Taylor reactors.

Examples of suitable copolymerization processes are described in patents DE-A-197 09 465, DE-C-197 09 476, DE-A-28 48 906, DE-A-195 24 182, EP-A-0 554 783, WO 95/27742 or WO 82/02387.

Examples of suitable hydroxyl-containing (meth)acrylate copolymers (B) are available commercially and are sold, for example, by Bayer AG under the brand name Desmophen® A, by DSM under the brand name Uracron® and by Synthopol under the brand name Synthalat®.

The amount of hydroxyl-containing (meth)acrylate copolymers (B) in the dual-cure coating materials for inventive use may vary very widely. It is guided in particular by the functionality and the amount of the constituent (A) and also any reactive diluents (C) present.

The constituents (A) and (B) or (B) and (C) and also (A) are preferably employed in a quantitative ratio (B):(A) or [(B)+(C)]:(A) such that the molar ratio of hydroxyl groups to isocyanate groups is from 3:1 to 1:2, more preferably from 2:1 to 1:1.5, and in particular from 1.5:1 to 1:1.

The third constituent of the dual-cure coating material for inventive use is at least one additive (C) selected from the group consisting of color and/or effect pigments, organic and inorganic, transparent or opaque fillers, nanoparticles, oligomeric and polymeric binders, reactive diluents curable thermally and/or with actinic radiation, crosslinking agents for the thermal cure, low and high-boiling organic solvents (long solvents), water, UV absorbers, light stabilizers, free-radical scavengers, thermolabile free-radical initiators, thermal crosslinking catalysts, devolatilizers, slip additives, polymerization inhibitors, defoamers, emulsifiers, wetting agents, dispersants, adhesion promoters, leveling agents, film-forming auxiliaries, sag control agents (SCA), rheology control additives (thickeners), flame retardants, siccatives, dryers, antiskinning agents, corrosion inhibitors, waxes, and flatting agents.

The nature and amount of the additives (C) are guided by the intended use of the coatings produced by means of the process of the invention.

Where the dual-cure coating material for inventive use is used for producing solid-color topcoats or basecoats, it comprises color and/or effect pigments (C) and also, where appropriate, opaque fillers. Where the dual-cure coating material for inventive use is used for producing clearcoats, those additives (C) are of course not present in it.

Examples of suitable effect pigments (C) are metal flake pigments such as standard commercial aluminum bronzes, aluminum bronzes chromated in accordance with DE-A-36 36 183, and standard commercial stainless steel bronzes, and also nonmetallic effect pigments, such as pearlescent pigment or interference pigment, for example. For further details, refer to Römpp Lexikon Lacke und Druckfarben, Georg Thieme Verlag, 1998, page 176, “Effect pigments” and pages 380 and 381 “Metal oxide-mica pigments” to “Metal pigments”.

Examples of suitable inorganic color pigments (C) are titanium dioxide, iron oxide, Sicotrans yellow, and carbon black. Examples of suitable organic color pigments (C) are thioindigo pigments indanthrene blue, Cromophthal red, Irgazine orange, and Heliogen green. For further details refer to Römpp Lexikon Lacke und Druckfarben, Georg Thieme Verlag, 1998, pages 180 and 181, “Iron blue pigments” to “Black iron oxide”, pages 451 to 453 “Pigments” to “Pigment volume concentation”, page 563, “Thioindigo pigments” and page 567 “Titanium dioxide pigments”.

Examples of suitable organic and inorganic fillers (C) are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers or wood flour. For further details, refer to Römpp Lexikon Lacke und Druckfarben, Georg Thieme Verlag, 1998, pages 250 ff., “Fillers”.

These pigments and fillers (C) may also be incorporated into the dual-cure coating materials using pigment pastes, in which case suitable grinding resins include the above-described hydroxyl-containing (meth)acrylate copolymers (B).

Examples of suitable binders (C) are thermally curable, hydroxyl-containing or actinic-radiation-curable linear and/or branched and/or block, comb and/or random poly(meth)acrylates or acrylate copolymers, polyesters, oligomers, polyurethans, acrylic polyurethanes, acrylic polyesters, polylactones, polycarbonates, polyethers, epoxy resin-amine adducts, (meth)acrylate diols, partially hydrolyzed polyvinyl esters or polyureas or actinic-radiation-curable (meth)acryloyl-functional (meth)acrylate copolymers, polyether acrylates, polyester acrylates, unsaturated polyesters, epoxy acrylates, urethane acrylates, amino acrylates, melamine acrylates, silicone acrylates, and the corresponding methacrylates.

Examples of suitable thermally curable reactive diluents (C) are positionally isomeric diethyloctanediols or hydroxyl-containing hyperbranched compounds or dendrimers.

Examples of suitable reactive diluents (C) curable with actinic radiation are those described in Römpp Lexikon Lacke und Druckfarben, Georg Thieme Verlag, Stuttgart, New York, 1998, on page 491 under the keyword “reactive diluents”.

Examples of suitable crosslinking agents (C) for thermal curing are amino resins, compounds or resins containing anhydride groups, compounds or resins containing epoxy groups, tris(alkoxycarbonylamino)triazines, compounds or resins containing carbonate groups, blocked and/or nonblocked polyisocyanates, beta-hydroxyalkylamides, and compounds containing on average at least two groups capable of transesterification, examples being reaction products of maleic diesters and polyisocyanates or of esters and partial esters of polyol alcohols of malonic acid with monoisocyanates, as described in European patent EP-A-0 596 460.

Examples of suitable low-boiling organic solvents (C) and high-boiling organic solvents (C) (“long solvents”) are ketones such as methyl ethyl ketone or methyl isobutyl ketone, esters such as ethyl acetate or butyl acetate, ethers such as dibutyl ether or ethylene glycol, diethylene glycol, propylene glycol, dipropylene glycol, butylene glycol or dibutylene glycol dimethyl, diethyl or dibutyl ether, N-methylpyrrolidone or xylenes or mixtures of aromatic hydrocarbons such as Solvent Naphtha® or Solvesso®.

Examples of suitable light stabilizers (C) are HALS compounds, benzotriazoles or oxalanilides.

Examples of suitable thermally labile free-radical initiators (C) are the above-described initiators employed in connection with the preparation of the hydroxyl-containing (metha)acrylate copolymers (B).

Examples of suitable crosslinking catalysts (C) are dibutyltin dilaurate, lithium decanoate or zinc octoate;

An example of a suitable devolatilizer (C) is diazadicycloundecane;

Examples of suitable emulsifiers (C) are nonionic emulsifiers, such as alkoxylated alkanols and polyols, phenols and alkylphenols or anionic emulsifiers such as alkali metal salts or ammonium salts of alkanecarboxylic acids, alkanesulfonic acids, and sulfo acids of alkoxylated alkanols and polyols, phenols and alkylphenols.

Examples of suitable wetting agents (C) are siloxanes, fluorine-containing compounds, carboxylic monoesters, phosphoric esters, polyacrylic acids and their copolymers or polyurethanes.

An example of a suitable adhesion promoter (C) is tricyclodecanedimethanol;

Examples of suitable film-forming auxiliaries (C) are cellulose derivatives.

Examples of suitable transparent fillers (C) are those based on silica, alumina or zirconium oxide; for further details refer to Römpp Lexikon Lacke und Druckfarben, Georg Thieme Verlag, Stuttgart, 1998, pages 250 to 252.

Examples of suitable sag control agents (C) are ureas, modified ureas and/or silicas, such as are described, for example, in references EP-A-192 304, DE-A-23 59 923, DE-A-18 05 693, WO 94/22968, DE-C-27 51 761, WO 97/12945 or “farbe+lack”, 11/1992, pages 829 ff.

Examples of suitable rheology control additives (C) are those known from patents WO 94/22968, EP-A-0 276 501, EP-A-0 249 201 and WO 97/12945; crosslinked polymeric microparticles, such as are disclosed, for example, in EP-A-0 008 127; inorganic phyllosilicates such as aluminum-magnesium silicates, sodium-magnesium and sodium-magnesium-fluorine-lithium silicates of the montmorillonite type; silicas such as Aerosils; or synthetic polymers containing ionic and/or associative groups, such as polyvinyl alcohol, poly(meth)acrylamide, poly(meth)acrylic acid, polyvinylpyrrolidone, styrene-maleic anhydride copolymers or ethylene-maleic anhydride copolymers and their derivatives or hydrophobically modified ethoxylated urethanes or polyacrylates;

One example of a suitable flatting agent (C) is magnesium stearate.

Further examples of the additives (C) listed above and also examples of suitable UV absorbers, free-radical scavengers, leveling agents, flame retardants, siccatives, dryers, antiskinning agents, corrosion inhibitors, and waxes (C) are described in detail in the textbook, “Lackadditive” [Additives for Coatings] by Johan Bieleman, Wiley-VCH, Weinheim, N.Y., 1998.

Moreover, water may be used as additive (C) if aqueous dual-cure coating materials are to be prepared.

The additives (C) are used in customary and known, effective amounts.

The preparation of the dual-cure compositions of the invention has no special features but instead takes place in a customary and known manner by mixing of the above-described constituents (A), (B), and (C) in suitable mixing equipment such as stirred tanks, dissolvers, stirrer mills or extruders in accordance with the techniques suitable for the preparation of the respective dual-cure compositions of the invention.

Since the dual-cure coating material for inventive use comprises a two-component system, in which constituent (A) has to be stored separately from constituent (B) up until the time of use, owing to its high reactivity, it is customary in this case to prepare a component I from constituents (A) and (C) and a component II from constituent (A) and also, where appropriate, an additive (C) which is inert toward isocyanate groups, particularly an organic solvent (C). Components I and II are then combined shortly before the use of the dual-cure coating materials.

The coatings produced with the aid of the process of the invention, especially the single-coat and multicoat clearcoat systems and color and/or effect paint systems, are of the upmost optical quality as far as color, effect, gloss and D.O.I. (distinctiveness of the reflected image) are concerned, have a smooth, structurless, hard, flexible, and scratch-resistant surface, are odorless and resistant to weathering, chemicals and etching, do not yellow, and exhibit no cracking or delamination of the coats.

The primed or unprimed substrates coated with these coatings therefore have a particularly long service life and a particularly high utility, so making them especially attractive, both technically and economically, for manufacturers, processors and end consumers.

### EXAMPLES AND COMPARATIVE EXPERIMENTS

### Examples 1 to 3 and Comparative Experiments C1 and C2

The preparation and production of clearcoat materials and clearcoats by the process of the invention (examples 1 to 3) and by the noninventive process (comparative experiments C1 and C2)

For examples 1 to 3, the constituents (A), (B) and (C) indicated in table 1 were mixed with one another, and for comparative experiments C1 and C2 constituents (A) and (C) indicated in table 1, and also the binders not for use in accordance of the invention, were mixed with one another. The mixing proportions were chosen so as to give a molar ratio of hydroxyl groups to isocyanate groups of 1.43.

TABLE 1
The composition of the clearcoat materials
for inventive use (examples 1 to 3 and of the clearcoat
materials not for inventive use (comparative
experiments C1 and C2)

| Example and comparative | | | | | |
|---|---|---|---|---|---|
| experiments | C1 | C2 | 1 | 2 | 3 |
| Roskydal ® 2337^{a)} | 11.6 | 8.2985 | 4.838 | 5.272 | 5.272 |
| Desmophen ® RD 181^{b)} | 11.2 | — | — | — | — |
| Uralac ® AN 623^{c)} | — | 12.86 | — | — | — |
| Uracron ® CY 467^{d)} | — | — | 19.248 | — | — |
| Uracron ® XP 476^{e)} | — | — | — | 16.36 | — |
| Desmophen ® A 450^{f)} | — | — | — | — | 19.091 |
| Butyl acetate | 11.2 | 12.853 | 19.248 | 15.454 | 19.091 |
| Solvent mixture^{g)} | 65.98 | 65.973 | 56.658 | 62.905 | 56.538 |
| Dibutyltin dilaurate^{ht)} | 0.02 | 0.014 | 0.008 | 0.009 | 0.008 |

^{a)}acrylated polyisocyanate from Bayer AG;
^{b)}hydroxyl-containing polyester from Bayer AG;
^{c)}hydroxyl-containing alkyd resin from DSM;
^{d)}hydroxyl-containing polyacrylate resin from DSM;
^{e)}hydroxyl-containing polyacrylate resin from DSM;
^{f)}hydroxyl-containing polyacrylate resin from Bayer AG;
^{g)}Methyl ethyl ketone/methyl isobutyl ketone/butyl acetate/ethyl acetate/xylene in a mixing ratio of 20/10/10/15/3;
^{h)}1% strength in xylene.

The clearcoat materials described above were applied to glass plates by means of a 200 μm box-type coating bar. After an evaporation time of 10 minutes they were physically predried in a forced air drier. Subsequent curing with UV radiation was carried out using two CK lamps (80 W/cm) with a travel speed of 5.5 m/min. The resultant clearcoats were left to cool for 10 minutes. Then their Konig pendulum hardness (DIN 53157; Römpp Lexikon Lacke und Druckfarben, Georg Thieme Verlag, Stuttgart, New York “Pendulum Attenuation Testing”, page 436) was measured. The experimental results can be found in table 2.

TABLE 2
The König pendulum hardness of the clearcoats
produced in an inventive procedure (examples 1 to 3)
and of the clearcoats produced in a noninventive
procedure (comparative experiments C1 and C2)

| Example and comparative | | | | | |
|---|---|---|---|---|---|
| experiments | C1 | C2 | 1 | 2 | 3 |
| Pendulum hardness (s): | — | — | 114.8 | 112 | 105 |

The experimental results make it clear that only the dual-cure clearcoat materials for inventive use are able to provide hard clearcoats.

1. A process for producing coatings from coating materials curable thermally and with actinic radiation on primed and unprimed substrates by
(1) applying at least one coating material curable thermally and with actinic radiation to the primed or unprimed substrate or to a basecoat film present thereon, to give a film of the coating material, and
(2) curing the film with heat and actinic radiation,
using a coating material which is composed of
A) at least one compound containing on average per molecule at least one free isocyanate group and at least one bond which can be activated with actinic radiation, and also
B) at least one hydroxyl-containing (meth)acrylate copolymer or at least one constituent (A), at least one constituent (B), and
C) at least one additive selected from the group consisting of color and/or effect pigments, organic and inorganic, transparent or opaque fillers, nanoparticles, oligomeric and polymeric binders, reactive diluents curable thermally and/or with actinic radiation, crosslinking agents for the thermal cure, low and high-boiling organic solvents (long solvents), water, UV absorbers, light stabilizers, free-radical scavengers, thermolabile free-radical initiators, thermal crosslinking catalysts, devolatilizers, slip additives, polymerization inhibitors, defoamers, emulsifiers, wetting agents, dispersants, adhesion promoters, leveling agents, film-forming auxiliaries, sag control agents (SCA), rheology control additives (thickeners), flame retardants, siccatives, dryers, antiskinning agents, corrosion inhibitors, waxes, and flatting agents.

2. The process of claim 1, characterized in that UV radiation is used as actinic radiation.

3. The process of claim 1 or 2, characterized in that carbon-hydrogen single bonds or carbon-carbon, carbon-oxygen, carbon-nitrogen, carbon-phosphorus or carbon-silicon single or double bonds are used as bonds which can be activated with actinic radiation.

4. The process of claim 3, characterized in that carbon-carbon double bonds are used.

5. The process of claim 4, characterized in that (meth)acrylate, ethacrylate, crotonate, cinnamate, vinyl ether, vinyl ester, dicyclopentadienyl, norbornenyl, isoprenyl, isopropenyl, allyl or butenyl groups; dicyclopentadienyl ether, norbornenyl ether, isoprenyl ether, isopropenyl ether, allyl ether or butenyl ether groups; or dicyclopentadienyl ester, norbornenyl ester, isoprenyl ester, isopropenyl ester, allyl ester or butenyl ester groups are used.

6. The process of claim 5, characterized in that acrylate groups are used.

7. The process of one of claims 1 to 6, characterized in that the coatings comprise single-coat and multicoat clearcoat systems and color and/or effect paint systems.

8. The process of one of claims 1 to 7, characterized in that the basecoat film is produced from a dual-cure coating material.

9. The process of one of claims 1 to 8, characterized in that the constituents (A) and (B) or (B) and (C) and also (A) are employed in a quantitative ratio (B):(A) or [(B)+(C)]:(A) such that the molar ratio of hydroxyl groups to isocyanate groups is from 3:1 to 1:2.
